(19) United States
(12) Patent Application Publication
(10) Pub. No.: US 2023/0296734 A1
(43) Pub. Date: Sep. 21, 2023

(54) OPTICAL SCANNING MULTIPLEXING DEVICES AND METHODS

(71) Applicant: CALIENT TECHNOLOGES, INC., Goleta, CA (US)

(72) Inventors: Michael INBAR, Santa Barbara, CA (US); Bhargav Srinath, Santa Barbara, CA (US); Arjun Gupta, Aspen, CO (US)

(73) Assignee: CALIENT TECHNOLOGES, INC., Goleta, CA (US)

(21) Appl. No.: 18/185,012

(22) Filed: Mar. 16, 2023

Related U.S. Application Data
(60) Provisional application No. 63/269,557, filed on Mar. 18, 2022.

(51) Int. Cl. G01S 7/481

(52) U.S. Cl. CPC G01S 7/4817; G01S 7/4815; G01S 7/4816

(57) ABSTRACT

Systems and devices for correcting a periodic signal includes receiving index light detection data from an optical scanner, determining a bias error of a moveable mirror in optical scanner based on the index light detection data, determining a phase shift error of the moveable mirror based on the index light detection data, and determining an amplitude error of the moveable mirror based on the index light detection data.

### CROSS REFERENCE TO RELATED APPLICATIONS

This application claims the benefit of U.S. Provisional Application No. 63/269,557, filed Mar. 18, 2022, entitled OPTICAL SCANNING MULTIPLEXING DEVICES AND METHODS which application is incorporated herein in its entirety by reference.

### BACKGROUND

Technical Field: The disclosure relates to optical scanning systems. For example, a scanning system includes a light source providing light, a mirror, and a light detector that detects the light reflected from the mirror.

Background: FIG. 1A illustrates the operational principle of optical scanner 102. As shown in FIG. 1A, the optical scanner 102 includes a moveable mirror 110 (e.g., oscillating mirror, rotating mirror), a light detector unit 112, and a light source unit 114. As shown in FIG. 1A, the light source unit 114 includes an array 122 of light sources 116 (e.g., array with M number of rows and N number of columns). The light detector unit 112 includes M number of light detectors 124. In other words, each light detector 124 of the light detector unit 112 corresponds to a single row of the light source array 122.

As shown, the moveable mirror 110 is positioned to receive light from the light source unit 114, and the light detector unit 112 is positioned to detect the light reflected or re-directed from the moveable mirror 110. As shown, an electromechanical device 111 (e.g., motor, step motor, servo motor) is provided to enable oscillating movement of the moveable mirror 110.

As shown in FIGS. 1B and 1C, as the angle of the moveable mirror 110 changes in response to the moveable mirror 110 oscillating or rotating about an axis (i.e., movement of the moveable mirror), light from a different light source 116 is received by the moveable mirror 110 onto the light detector unit 112. As shown in FIG. 1B, the moveable mirror 110 (instantaneous angle Θ of the moveable mirror 110 is 0° in this example) is positioned to reflect or re-direct light from a light source 116x onto the light detector unit 112 (e.g., light detector 124 of the light detector unit 112). As shown in FIG. 1C, the moveable mirror 110 (instantaneous angle Θ of the moveable mirror 110 is x° in this example), which is at a different position, the moveable mirror 110 is positioned to reflect or re-direct light from a light source 116y onto the light detector unit 112 (e.g., light detector 124 of the light detector unit 112).

The light detector unit 112 generates an output signal (e.g., analog signal) based on the light (e.g., intensity of the light) detected or received from the moveable mirror 110. The generated analog signal is then digitized and further processed by an appropriate processor (not shown) in communication with the light detector unit 112.

As will be appreciated by those skilled in the art, the nature of processing the analog signal can vary between simple processing to highly complex processing depending on the application.

The instantaneous angle Θ of the moveable mirror 110 (also referred to as scanning mirror) may be controlled using a signal or current based on a function provided to the electromechanical device 111. For example, the instantaneous angle Θ is determined by:

$$\text{θ} \left(\text{t}\right) = \text{k} \times \text{I} \left(\text{t}\right) \qquad \text{(EQ. 1)}$$

wherein Θ(t) is the instantaneous angle of the moveable mirror 110 at time t, I(t) is the variable current or signal (e.g., variable current or signal that drives the electromechanical device 111) provided at time t, and k (also referred to as amplitude or scan amplitude) is the proportionality constant (which may vary by optical scanner manufacturer and/or from optical scanner to optical scanner). To increase the efficiency of scanning operation, a scanning system may incorporate multiple optical scanners.

What is needed are methods, devices and systems for controlling a plurality of optical scanners with a single set of electronics, for correcting a bias error in a scanning mirror of each of the optical scanners, for compensating for a phase response of the scanning mirror of each of the optical scanners, and/or for adjusting the proportionality constant k.

### SUMMARY

Disclosed are methods, devices and systems for controlling a plurality of optical scanners with a single set of electronics, for correcting a bias error in a scanning mirror of each of the optical scanners, for compensating for a phase response of a scanning mirror of each of the optical scanners, and/or for adjusting the proportionality constant k. In this disclosure, index light sources (e.g., row of index light sources) provide or emit constant light that is being used to track or monitor the movement of the scanning mirror. Based on analysis of the movement of the scanning mirror, the system is able to correct the bias error in the scanning mirror of each of the optical scanners, to compensate for the phase response of the scanning mirror of each of the optical scanners, and/or to adjust the proportionality constant k.

One aspect of the disclosure provides a method for correcting a periodic signal. The method includes receiving, at one or more processors, index light detection data from an optical scanner. The method also includes determining, by the one or more processors, a bias error of a moveable mirror of the optical scanner based on the index light detection data. The method further includes determining, by the one or more processors, a phase shift error of the moveable mirror of the optical scanner based on the index light detection data. The method also includes determining, by the one or more processors, an amplitude error of the moveable mirror of the optical scanner based on the index light detection data.

Implementations of the disclosure may include one or more of the following optional features: Determining the amplitude error of the moveable mirror may include determining a time interval between two consecutive pulses generated by a right index light in the index light detection data. In response to a determination that there is the amplitude error, the method may include adjusting, by the one or more processors, an amplitude of a function that is being used to generate a signal that drives the moveable mirror. Determining the phase shift error of the moveable mirror may include determining a time interval between a first time a middle index pulse is generated by detecting a middle index light and a second time the middle index pulse is supposed to be generated. In response to a determination that there is the phase shift error, the method may include adding, by the one or more processors, an offset phase shift to a function that is being used to generate a signal that drives the moveable mirror. Determining the bias error of the moveable mirror may include determining a first time interval between two consecutive pulses generated by a right index light in the index light detection data, and determining a second time interval between two consecutive pulses generated by a left index light in the index light detection data. In response to a determination that there is the bias error, the method may include adding, by the one or more processors, an offset bias to a function that is being used to generate a signal that drives the moveable mirror.

Another aspect of the disclosure provides a system that is configurable to include data processing hardware (e.g., one or more processors) and memory hardware in communication with the data processing hardware. The memory hardware is configurable to store instructions that when executed on the data processing hardware cause the data processing hardware to perform operations. The operations performed include, for example, one or more of receiving index light detection data from an optical scanner, determining a bias error of a moveable mirror of the optical scanner based on the index light detection data, determining a phase shift error of the moveable mirror of the optical scanner based on the index light detection data, and/or determining an amplitude error of the moveable mirror of the optical scanner based on the index light detection data.

Implementations of the disclosure may include one or more of the following optional features: Determining the amplitude error of the moveable mirror may include determining a time interval between two consecutive pulses generated by a right index light in the index light detection data. In response to a determination that there is the amplitude error, the operations may include adjusting an amplitude of a function that is being used to generate a signal that drives the moveable mirror. Determining the phase shift error of the moveable mirror may include determining a time interval between a first time a middle index pulse is generated by detecting a middle index light and a second time the middle index pulse is supposed to be generated. In response to a determination that there is the phase shift error, the operations may include adding an offset phase shift to a function that is being used to generate a signal that drives the moveable mirror. Determining the bias error of the moveable mirror may include determining a first time interval between two consecutive pulses generated by a right index light in the index light detection data, and determining a second time interval between two consecutive pulses generated by a left index light in the index light detection data. In response to a determination that there is the bias error, the operations may include adding an offset bias to a function that is being used to generate a signal that drives the moveable mirror.

Another aspect of the disclosure provides a scanning system. The scanning system is configurable to include a drive function generator that is configurable to generate a plurality of periodic signals. The plurality of periodic signals can include, for example, at least a first periodic signal and a second periodic signal. The system is also configurable to include a plurality of optical scanners. The plurality of optical scanners can include, for example, a first optical scanner and a second optical scanner. The system is also configurable to include a first mirror of the first optical scanner and a second mirror of the second optical scanner. The first mirror oscillates based on the first periodic signal and the second mirror oscillates based on the second periodic signal. The first periodic signal has a first phase shift and the second periodic signal has a second phase shift different from the first phase shift.

Implementations of the disclosure may include one or more of the following optional features. The first phase shift may be 0, and the second phase shift may be ¼ period of the second periodic signal. The drive function generator may generate the first periodic signal based on a first sine function with a first phase shift. The drive function generator may generate the second periodic signal based on the first sine function with a second phase shift. The first phase shift may be 0, and the second phase shift may be ¼ period of the first sine function.

The first optical scanner may include a light source device including an array of light sources, a first index light source, a second index light source, and a third index light source. The first index light source may be aligned with a first column of the array of light sources, and the second index light source may be aligned with a last column of the array of light sources. The third index light source may be aligned with a center line between a first column of the array of light sources and a last column of the array of light sources. In some circumstances, the third index light source may be aligned with a middle column of the array of light sources. The first optical scanner may include a light detector unit including a light detector corresponding to one row of the array of light sources and an index light detector disposed to detect index light from the first index light source, the second index light source, and the third index light source. The system may include a scan data processor configurable to receive scan data from the plurality of optical scanners.

Both the foregoing general description and the following detailed description are exemplary and explanatory only and are not restrictive of the disclosed embodiments, as claimed.

### INCORPORATION BY REFERENCE

All publications, patents, and patent applications mentioned in this specification are herein incorporated by reference to the same extent as if each individual publication, patent, or patent application was specifically and individually indicated to be incorporated by reference.
US 5,557,444 A issued Sep. 17, 1996 to Melville et al.;
US 5,956,355 A issued Sep. 21, 1999 to Swanson et al.;
US 6,396,561 B1 issued May 28, 2002 to Vernackt et al.;
US 7,485,485 B2 issued Feb. 3, 2009 to Linden et al.;
US 8,294,454 B2 issued Oct. 23, 2012 to Siraky;
US 8,427,657 B2 issued Apr. 23, 2013 to Milanovi;
US 8,649,079 B2 issued Feb. 11, 2014 to Naono;
US 9,122,061 B2 issued Sep. 1, 2015 to Azuma;
US 9,874,434 B2 issued Jan. 23, 2018 to Holzapfel;
US 10,571,552 B1 issued Feb. 25, 2020 to Gao et al.;
US 11,112,491 B2 issued Sep. 7, 2021 to Abediasl et al.;
US 2004/0095623 A1 published May 20, 2004 to Barresi et al.;
US 2020/0319450 A1 published Oct. 8, 2020 to Druml et al.;
US 2021/0011133 A1 published Jan. 14, 2021 to Morarity et al.;
RIZA, et al., I-WMOSS: Interferometric Wavelength Multiplexed Optical Scanning Sensor, IEEE, International Symposium on Optomechatronic Technologies, ISOT (October 2012); and
RIZA, MOST: Multiplexed Optical Scanner Technology, IEEE Lasers and Electro-Optics Society 2000 Annual Meeting (November 2000).

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIGS. 1A-1C illustrate a principle of optical scanner operation;

FIGS. 2A-2C illustrate an example optical scanner including a light source unit including a light source array and a row of index light sources, a light detector unit configured to detect light from the light source array and index light from the row of the index light sources, and a moveable mirror in accordance with some embodiments of the this disclosure;

FIG. 3 illustrates a first amplitude of a first periodic function which encompasses a range between a positive instantaneous angle and a negative instantaneous angle over time in accordance with some embodiments of this disclosure;

FIG. 4 illustrates a first amplitude of a first periodic function and a second amplitude of a second periodic function whose respective amplitudes encompass a range between the positive instantaneous angle and the negative instantaneous angle over time in accordance with some embodiments of this disclosure;

FIG. 5A and FIG. 5B illustrate block diagrams of an example scanning system configured with a plurality of optical scanners in accordance with some embodiments of this disclosure;

FIG. 6A and FIG. 6B illustrate block diagrams of an example scanning system including a first optical scanner and a second optical scanner in accordance with some embodiments of this disclosure;

FIG. 6C illustrates a first periodic signal for a first moveable mirror of a first optical scanner and a second moveable mirror of a second periodic signal for a second optical scanner in accordance with some embodiments of this disclosure;

FIG. 6D illustrates index light detection data including pulse signals from detecting right index light, left index light, and middle index light in accordance with some embodiments of this disclosure; and

FIG. 6E illustrates index light detection data including a pulse signal from detecting middle index light in accordance with some embodiments of this disclosure.

FIG. 7 illustrates a flowchart of an example method of controlling a scanning system configured with a plurality of optical scanners.

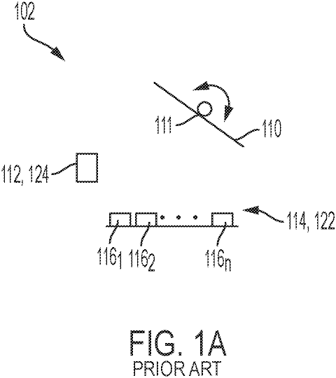

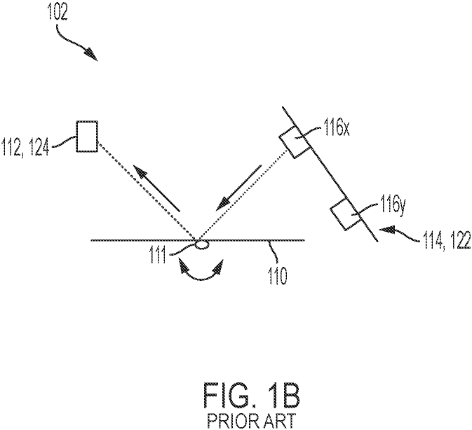

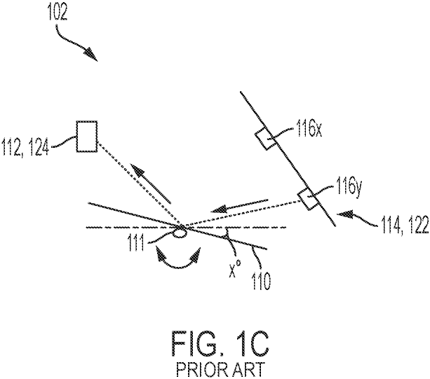

Like reference symbols in the various drawings indicate like elements.

### DETAILED DESCRIPTION

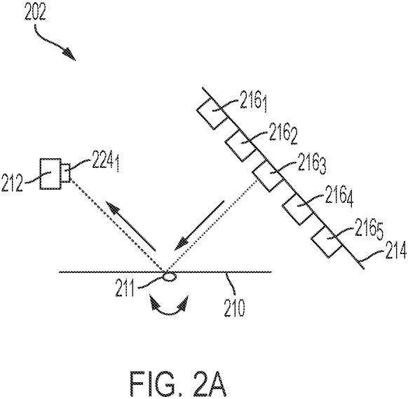

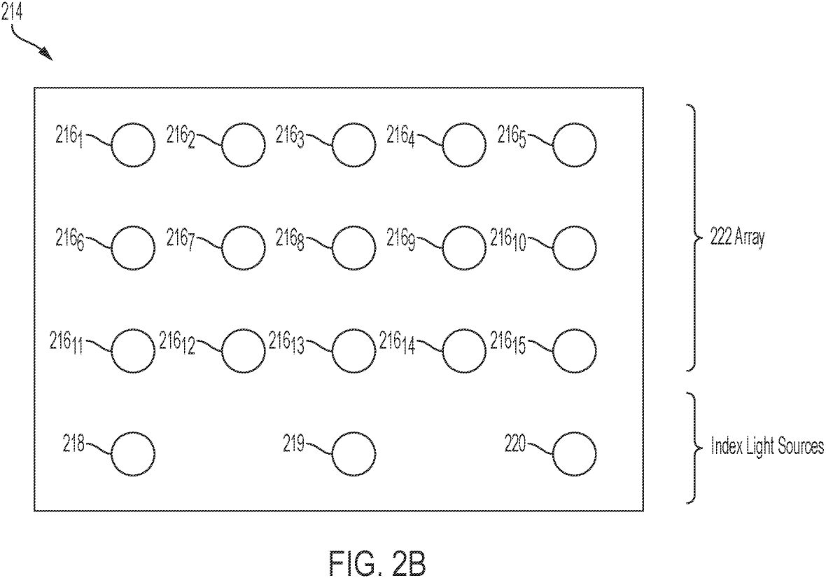

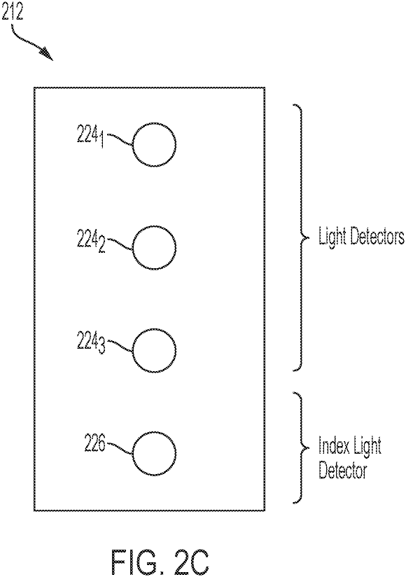

FIG. 2A illustrates a view of an example optical scanner 202 configured with a moveable mirror 210 (e.g., oscillating mirror) in accordance with some embodiments of this disclosure. FIG. 2B illustrates a planar view of an example light source unit 214 including a light source array 222 in FIG. 2A. FIG. 2C illustrates a planar view of an example light detector unit 212 in FIG. 2A. As shown in FIG. 2A and FIG. 2B, the light source unit 214 includes a first light source 216₁ disposed along the first column of the array 222 and a fifth light source 216s disposed along the fifth column (last column in this example) of the array 222.

As shown in FIG. 2A and FIG. 2B, the example optical scanner 202 includes the light source unit 214 that includes a plurality of light sources 216₁₋₁₅ and a plurality of index light sources (e.g., a first index light source 218, a second index light source 219, and a third index light source 220). In this example, the index light sources 218, 219, 220 provide or emit constant light since the light from the index light sources 218, 219, 220 is used to track or monitor the movement of the moveable mirror 210. The light sources 216₁₋₁₅ and the index light sources 218, 219, 220 can be optical fiber terminations or tips emitting light generated by a light generator such as a laser generator (not shown). However, the present disclosure does not limit the light sources 216₁₋₁₅ and the index light sources 218, 219, 220 to optical fiber tips. For example, the light sources 216₁₋₁₅ and the index light sources 218, 219, 220 may include light emitting devices or suitable devices that can provide light to the moveable mirror 110.

As shown, in this example, the plurality of light sources 216₁₋₁₅ of the light source unit 214 forms a 3 (rows) × 5 (columns) array 222. The first index light source 218 (also referred to as left index light) is shown disposed along the first column of the array 222, the second index light source 219 (also referred to as middle index light) is shown disposed along the third column (also referred to as middle column) of the array 222, and the third index light source 220 (also referred to as right index light) is shown disposed along the fifth column of the array 222. In other words, the left index light 218 is aligned with the far left column of the array 222, the middle index light 219 is aligned with the middle column of the array 222, and the right index light 220 is aligned with the far right column of the array 222. In some circumstances, the middle index light 219 is aligned with a center line between the left index light 218 and the right index light 220. As shown, each of the light sources 216₁₋₁₅ is spaced apart from each other. In FIG. 2B, the example light source unit 214 has the array 222 with three rows and five columns. However, the present disclosure does not limit the number of rows and the number of columns in the array 222 to the example illustrated. For example, the array 222 of the light source unit 214 may include up to 384 light sources 216 (e.g., array 222 with 16 rows and 24 columns).

As shown in FIG. 2A and FIG. 2C, the example optical scanner 202 includes the light detector unit 212 that includes a plurality of light detectors 224₁₋₃ and an index light detector 226. The light detector unit 212 is configurable to include a first light detector 224₁ corresponding to the light sources 216₁₋₅ in the first row of the array 222 in the FIG. 2B, a second light detector 224₂ corresponding to the light sources 216₆₋₁₀ in the second row of the array 222 in the FIG. 2B, and a third light detector 224₃ corresponding to the light sources 216₁₁₋₁₅ in the third row of the array 222 in the FIG. 2B. As shown, the light detector unit 212 includes an index light detector 226 corresponding to the index light sources 218, 219, 220. The light detectors 224₁₋₃ and the index light detector 226 are optical fiber terminations or tips configured to receive lights from the light source unit 214. The light received by the light detectors 224₁₋₃ can be channeled to a light/index light detection device 508/608 (e.g., light detection circuitry) which is configurable to convert the light into electrical signals (e.g., converting the light to analog signals). Additionally, the index light received by the index light detector 226 can be channeled to the light/index light detection device 508/608 which is also configurable to convert the light into electrical signals (e.g., converting the index light to pulse signals).

Additional details regarding the light/index light detection device 508/608 is described elsewhere in the disclosure. As shown in FIG. 2B and FIG. 2C, the number of light detectors 224 in the light detector unit 212 corresponds to the number of rows in the array 222. For example, when the light source unit 214 includes an array 222 with 16 rows and 24 columns, the light detector unit 212 includes 16 light detectors 224 and 1 index light detector 226.

As shown in FIG. 2A, an electromechanical device 211 (e.g., motor, step motor, servo motor) may be coupled to the moveable mirror 210, and the electromechanical device 211 may move or oscillate the moveable mirror 210. As the angle of the moveable mirror 210 changes in response to the moveable mirror 210 oscillating or rotating about an axis, lights from a different column of light sources 216 are received by the moveable mirror 210 onto the light detector unit 212. The moveable mirror 210 (e.g., oscillating mirror) in FIG. 2A is positioned to reflect or re-direct the light from the third light source 216₃. The moveable mirror 210 also reflects or redirects the light from the eighth light source 216₈ and the thirteenth light source 216₁₃, and the second index light source 219 (i.e., light sources/index light source in the middle column) (shown in FIG. 2B) onto the first light detector 224₁, and the second light detector 224₂, and third light detector 224₃ shown in FIG. 2C, as well as the index light detector 226, respectively, also shown in FIG. 2C. As the moveable mirror 210 rotates in a first direction (e.g., clockwise), the moveable mirror 210 (e.g., oscillating mirror) is positioned to reflect or re-direct the light from the fourth light source 216₄, the ninth light source 216₉, and the fourteenth light source 216₁₄ onto the first light detector 224₁, the second light detector 224₂, the third light detector 224₃, respectively.

As the moveable mirror 210 continues to rotate in the first direction (e.g., clockwise), the moveable mirror 210 (e.g., oscillating mirror) reflects or re-directs the light from the fifth light source 216₅, the tenth light source 216₁₀, fifteenth light source 216₁₅, and the third index light source 220 (i.e., light sources/index light source in the far right column) onto the first light detector 224₁, the second light detector 224₂, the third light detector 224₃, and the index light detector 226, respectively.

As the moveable mirror 210 changes from rotating in the first direction to rotating in a second direction (e.g., counter clockwise), the moveable mirror 210 (e.g., oscillating mirror) returns to the previous position to reflect or re-direct the light from the fifth light source 216₅, the tenth light source 2169₁₀, fifteenth light source 216₁₅, and the third index light source 220 (i.e., light sources/index light source in the far right column) onto the first light detector 224₁, the second light detector 224₂, the third light detector 224₃, and the index light detector 226, respectively. As the moveable mirror 210 continues rotating in the second direction (e.g., counter clockwise), the moveable mirror 210 (e.g., oscillating mirror) reflects or re-directs the light from the fourth light source 216₄, the ninth light source 216₉, and the fourteenth light source 216₁₄ onto the first light detector 224₁, the second light detector 224₂, the third light detector 224₃, respectively.

As the moveable mirror 210 continues rotating to the second direction (e.g., counter clockwise), the moveable mirror 210 (e.g., oscillating mirror) is positioned to reflect or re-direct the light from the third light source 216₃, the eighth light source 216₈, the thirteenth light source 216₁₃, and the second index light source 219 (i.e., light sources/index light source in the middle column) onto the first light detector 224₁, the second light detector 224₂, the third light detector 224₃, and the index light detector 226, respectively. Continued rotation in the second direction (e.g., counter clockwise), causes the moveable mirror 210 (e.g., oscillating mirror) to reflect or re-direct the light from the second light source 216₂, the seventh light source 216₇, and the twelfth light source 216₁₂ onto the first light detector 224₁, the second light detector 224₂, and the third light detector 224₃, until the moveable mirror reflects or re-directs light from the first light source 216₁, the sixth light source 216, the eleventh light source 216₁₁, the first index light source 218 (i.e., light sources/index light source in the far left column) onto the first light detector 224₁, the second light detector 224₂, the third light detector 224₃, and the index light detector 226, respectively.

Once the moveable mirror 210 reaches the end of a rotation path in to the second direction, the moveable mirror 210 changes the rotating direction to the first direction, at which point the moveable mirror 210 (e.g., oscillating mirror) returns to the previous position to reflect or re-direct the light from the first light source 216₁, the sixth light source 216₆, the eleventh light source 216₁₁, and the first index light source 218 onto the first light detector 224₁, the second light detector 224₂, the third light detector 224₃, and the index light detector 226, respectively. Thus the moveable mirror 210 has a rotation path that causes the moveable mirror to move through a range of motion about an axis for the rotation path. Once the moveable mirror 210 reaches a first end of the rotation path, the moveable mirror 210 reverses direction about the axis and rotates to a second end of the rotation path. During the rotation, the moveable mirror 210 affects the mapping of a light source column unto the array 222. Thus, the selection of a light source column in the light source array 222 is a function of tilt angle of the moveable mirror 210. Since the tilt angle is periodic in time, the resulting mapping will be periodic as well.

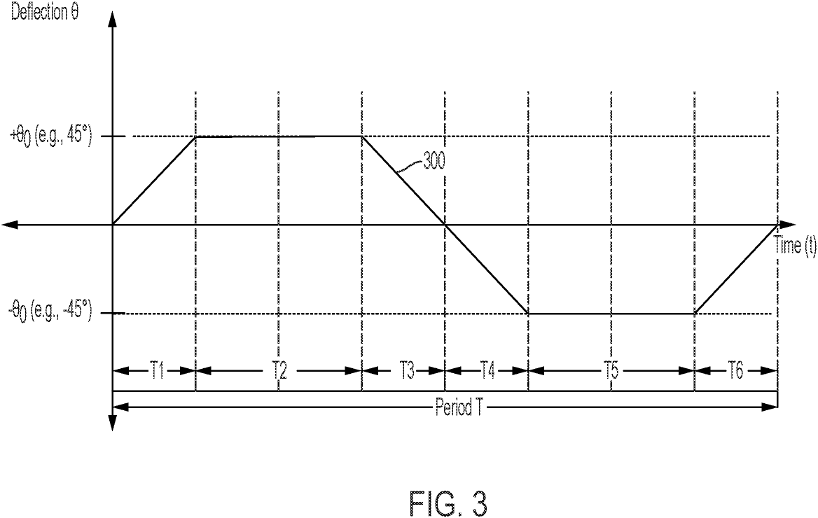

FIG. 3 illustrates an example periodic function 300 which encompasses a range between a positive instantaneous angle Θ (+Θ₀) and a negative instantaneous angle Θ (-Θ₀) in accordance with some embodiments of the disclosure. The instantaneous angle is also referred to as deflection or scanning angle. In this example, the range between the +Θ₀ and the -Θ₀ may correspond to a scan across the source array 222 between the left most column of the array 222 and the right most column of the array 222. The instantaneous angle Θ of the moveable mirror 210 (e.g., scan angle of the moveable mirror 210) is oscillating between +Θ₀. Said another way, Θ₀ = Θ(T1) where T1 = ⅛ • Period = 45 degrees.

As shown in FIG. 3, the instantaneous angle Θ of the moveable mirror 210 changes over time t. The instantaneous angle Θ of the moveable mirror 210 is 0° when the moveable mirror 210 is in a horizontal position. As a result, the moveable mirror 210 is positioned to reflect the light from the light source unit 214 (e.g., light from light sources/index light source in the middle column) onto the light detector unit 212. The cycle illustrated has 45 degrees.

As discussed above, the moveable mirror 210 may be configured to oscillate or rotate. The instantaneous angle Θ of the moveable mirror 210 changes from 0° to +Θ (in this example, Θ₀ =20°) during a first portion T₁ of the period T (e.g., ⅛ of the period T). As a result, the moveable mirror 210 is positioned to reflect the light from the light source unit 214 (e.g., light from light sources/index light source in the far right column) onto the light detector unit 212. As shown, the instantaneous angle Θ of the moveable mirror 210 remains at the Θ₀ for a second portion T₂ of the period T (e.g., ¼ or 2/8 of the period T), changes from Θ₀ to 0° during a third portion T3 of the period T (e.g., ⅛ of the period T), and changes from 0° to -Θ₀ (in this example, -Θ₀ = –20°) during a fourth portion T₄ of the period T (e.g., ⅛ of the period T). As a result, the moveable mirror 210 is positioned to reflect the light from the light source unit 214 (e.g., light from light sources/index light source in the far left column) onto the light detector unit 212. As shown, the instantaneous angle Θ of the moveable mirror 210 remains at the -Θ₀ for a fifth portion T₅ of the period T (e.g., ¼ or 2/8 of the period T) and changes from -Θ₀ (e.g., -20°) to 0° during a sixth portion T₆ of the period T (e.g., ⅛ of the period T).

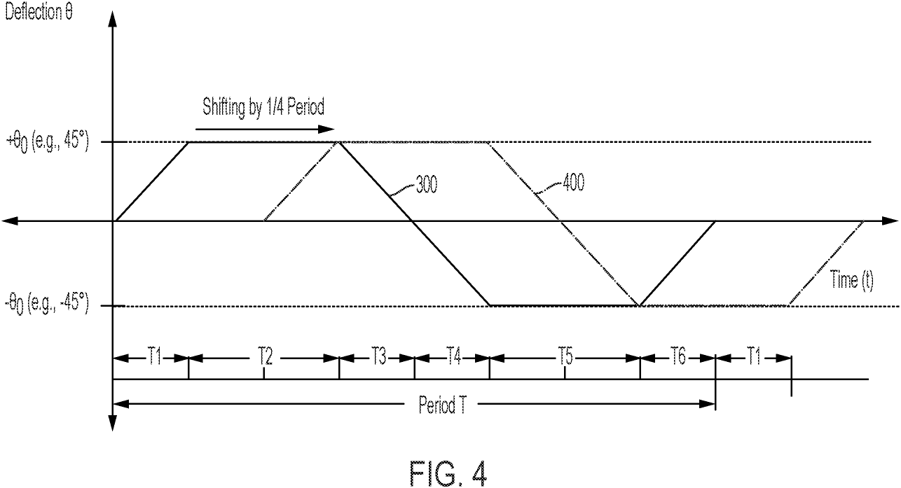

FIG. 4 illustrates the example periodic function 300 (“first periodic function”) in FIG. 3 and another example periodic function 400 (“second periodic function”) which encompass a range between the positive instantaneous angle Θ (+Θ₀) and the negative instantaneous angle Θ (-Θ₀) in accordance with some embodiments of this disclosure. In this example, a first moveable mirror 210₁ of a first optical scanner 202₁ rotates or oscillates based on the first periodic function 300, and a second moveable mirror 210₂ of a second optical scanner 202₂ rotates or oscillates based on the second periodic function 400. The second moveable mirror 210₂ of the second optical scanner 202₂ oscillates or rotates based on the same periodic function that drives the first moveable mirror 210₁. However, as shown, the phase of the second periodic function 400 is shifted by ¼ of period T.

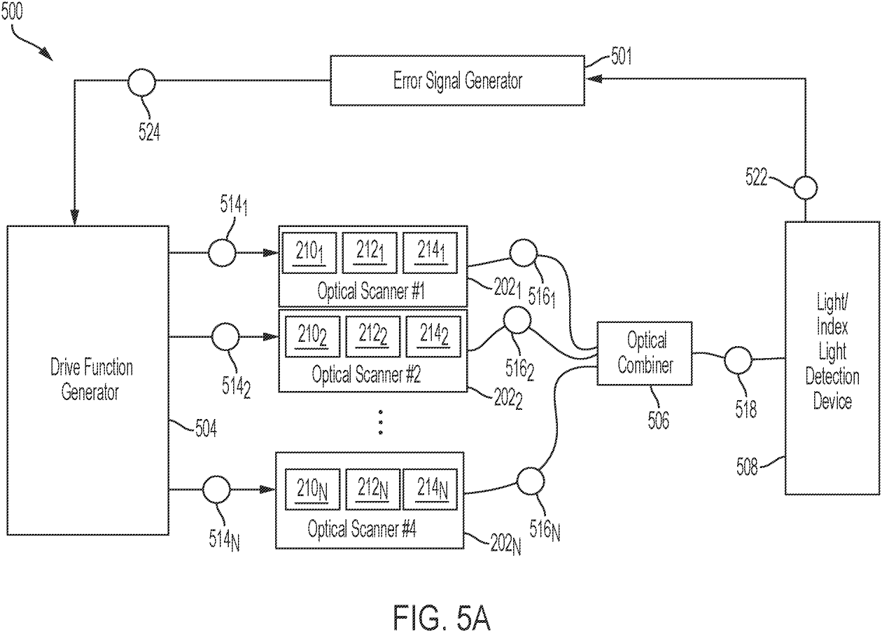

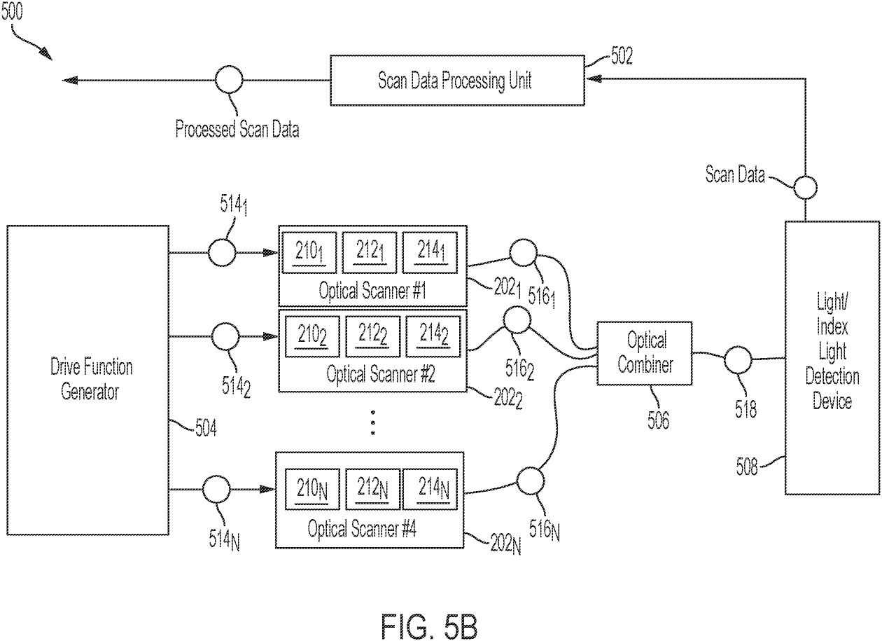

Turning now to FIG. 5A a block diagram of an example scanning system 500 configured with a drive function generator 504, a plurality of optical scanners 202_{1...N}, an optical combiner 506, a light/index light detection device 508, and an error signal generator 501 is illustrated. Each of the optical scanners 202 includes a light detector unit 212, a light source unit 214, a moveable mirror 210 (e.g., oscillating mirror) that is configured to oscillate based on a corresponding periodic signal 514 (e.g., signal based on sine function, signal based on cosine function) from the drive function generator 504. In this example, the drive function generator 504 generates the periodic signals 514 with different phase shifts. As a result, each of the moveable mirrors 210 oscillates based on the periodic signal 514 with a different phase. For example, the drive function generator 504 provides a first periodic signal 514₁ to a first optical scanner 202₁ based on a sine function with a first phase shift (0 phase shift in this example) and provides a second periodic signal 514₂ to a second optical scanner 202₂ based on the sine function with a second phase shift (¼ period of phase shift in this example).

Additionally, each of the optical scanners, e.g. first optical scanner 202₁ to optical scanner 202_{N} referred to collectively as optical scanners 202_{1...N}, are connected to the optical combiner 506 (e.g., via optical fiber). Thus, in this example, each of the optical scanners 202_{1...N} is configured to transmit light information or light signals 516_{1-N} including light/index light detected from the light detectors 224₁₋₃ and index light detector 226 to the optical combiner 506. As a result, the optical combiner 506 combines the light signals 516_{1-N} into a combined light signal 518. The light detected from the first light detector 224₁ of the first optical scanner 202₁, the light detected from the first light detector 224₁ of the second optical scanner 202₂, and the light detected from the first light detector 224₁ of the Nth optical scanner 202_{N} are combined at the optical combiner 506 (resulting a first combined light signal 518₁). Similarly, the light detected from the second light detector 224₂ of the first optical scanner 202₁, the light detected from the second light detector 224₂ of the second optical scanner 202₂, and the light detected from the third light detector 224₃ of the Nth optical scanner 202_{N} are combined at the optical combiner 506 (resulting a second combined light signal 518₂). Likewise, the light detected from the third light detector 224₃ of the first optical scanner 202₁, the light detected from the third light detector 224₃ of the second optical scanner 202₂, and the light detected from the third light detector 224₃ of the Nth optical scanner 202_{N} are combined at the optical combiner 506 (resulting a third combined light signal 518₃). Similarly, the index light detected from the index light detector 226 of the first optical scanner 202₁, the index light detected from the index light detector 226 of the second optical scanner 202₂, and the index light detected from the index light detector 226 of the Nth optical scanner 202_{N} are combined at the optical combiner 506 (resulting a combined index light signal 518₁). The combined light signal 518 includes the first combined light signal 518₁, the second combined light signal 518₂, the third combined light signal 518₃, and the combined index light signal 518₁.

The light/index light detection device 508 is configurable to detect the combined index light signal 518₁ from the optical combiner 506 and generates an index light detection data 522 (including pulse signals in this example). Additionally, the error signal generator 501 (also referred as to feedback generator) generates feedback data 524 based on the index light detection data 522. The drive function generator 504 may also generate a plurality of periodic signals (e.g., first periodic signal 514₁ to periodic signal 514_{N}, referred to collectively as periodic signals 514_{1...N}) based on the feedback 524 from the feedback generator 501.

FIG. 5B illustrates a block diagram of an example scanning system 500 configured with a scan data processing unit 502 in accordance with some embodiments of this disclosure. The light/index light detection device 508 is configurable to detect the first combined light signal 518₁, the second combined light signal 518₂, the third combined light signal 518₃ from the optical combiner 506 and generates scan data (including analog signals in this example). Additionally, the scan data processing unit 502 is configured to process the scan data from the light/index light detection device 508 and to generate processed scan data (e.g., digital scan data).

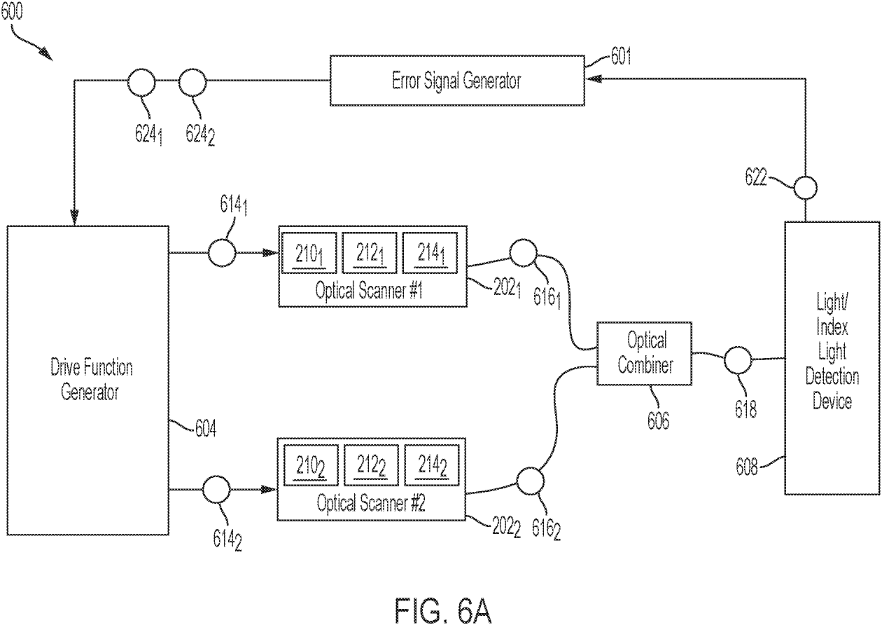

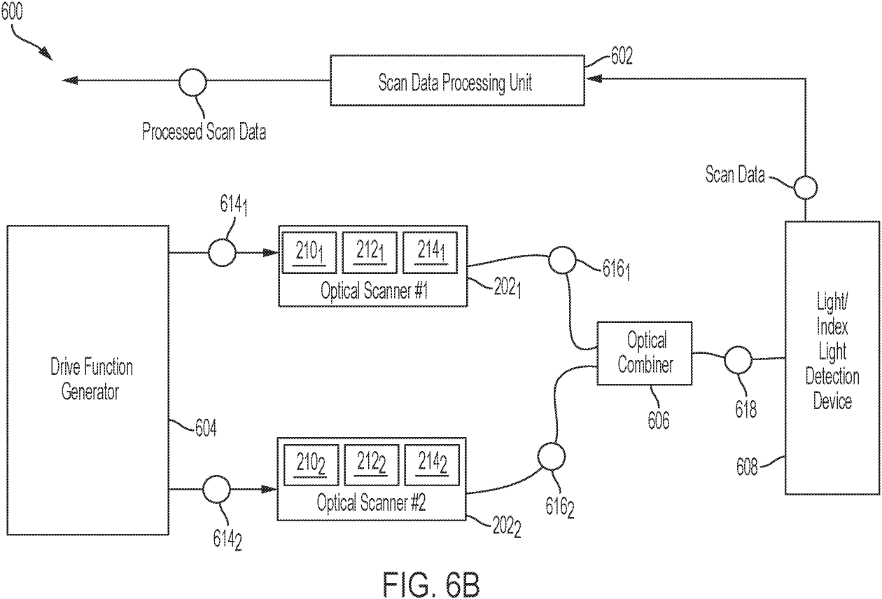

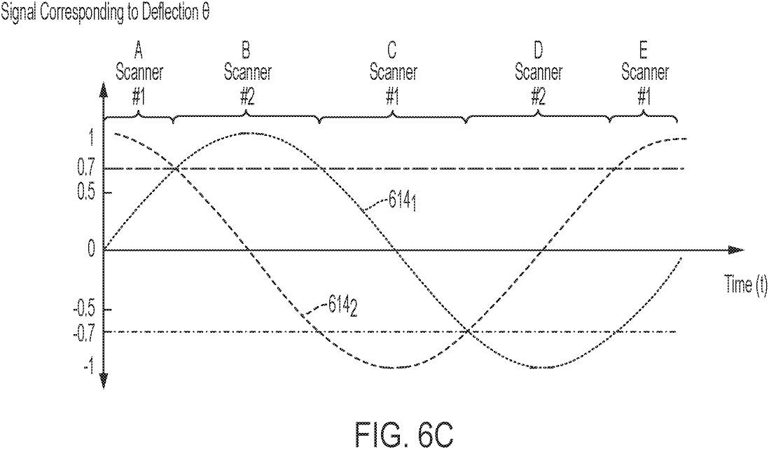

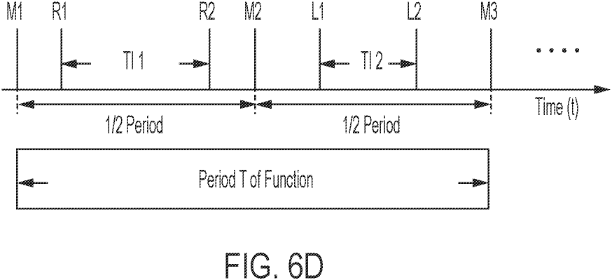

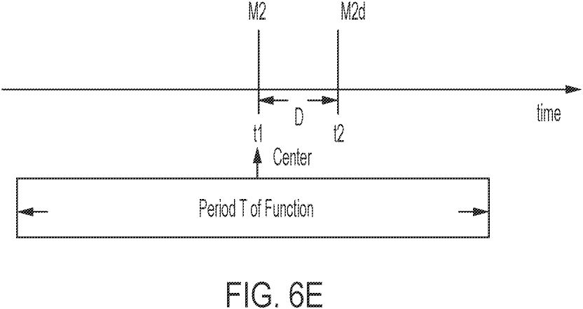

FIG. 6A illustrates a block diagram of an example scanning system 600 configured with a drive function generator 604, a first optical scanner 202₁, a second optical scanner 202₂, an optical combiner 606, a light/index light detection device 608, and an error signal generator 601 in accordance with some embodiments of this disclosure. Each of the optical scanners 202_{1,2} includes a light detector unit 212, a light source unit 214, a moveable mirror 210 (e.g., oscillating mirror) that is configured to oscillate based on a corresponding periodic signal 614 (e.g., signal based on sine function, signal based on cosine function) from the drive function generator 604. The drive function generator 604 can be configurable to provide a first periodic signal 614₁ to a first optical scanner 202₁ based on a sine function with a first phase shift (0 phase shift in this example) and provides a second periodic signal 614₂ to a second optical scanner 202₂ based on the cosine function which is equivalent to the sine function with a second phase shift (e.g., ¼ period of phase shift). Additionally, each of the optical scanners 202_{1,2} is in communication with the optical combiner 606 (e.g., via optical fiber communication). In this example, each of the optical scanners 202 is configured to transmit light information or light signals 616_{1,2} including light/index light detected from the light detectors 224₁₋₃ and index light detector 226. As a result, the optical combiner 606 combines the light signals 616_{1,}₂ into a combined light signal 618. For example, the light detected from the first light detector 224₁ of the first optical scanner 202₁ and the light detected from the first light detector 224₁ of the second optical scanner 202₂ are combined at the optical combiner 606 (resulting a first combined light signal 618₁). Similarly, the light detected from the second light detector 224₂ of the first optical scanner 202₁ and the light detected from the second light detector 224₂ of the second optical scanner 202₂ are combined at the optical combiner 606 (resulting a second combined light signal 618₂). Likewise, the light detected from the third light detector 224₃ of the first optical scanner 202₁ and the light detected from the third light detector 224₃ of the second optical scanner 202₂ are combined at the optical combiner 606 (resulting a third combined light signal 618₃). Similarly, the index light detected from the index light detector 226 of the first optical scanner 202₁ and the index light detected from the index light detector 226 of the second optical scanner 202₂ are combined at the optical combiner 606 (resulting a combined index light signal 618₁). In this example, the combined light signal 618 includes the first combined light signal 618₁, the second combined light signal 618₂, the third combined light signal 618₃, and the combined index light signal 618₁.

The light/index light detection device 608 can also be configurable to detect the combined index light signal 618₁ from the optical combiner 606 and generates an index light detection data 622 (including pulse signals in this example). The error signal generator 601 (also referred as to feedback generator) generates feedback data 624_{1,} ₂ (or feedback) based on the index light detection data 622, and the drive function generator 604 may generate the first periodic signal 614₁ based on the first feedback data 624₁ and the second periodic signal 614₂ based on the second feedback 624₂ from the feedback generator 601.

FIG. 6B illustrates a block diagram of an example scanning system 600 configured with a scan data processing unit 602. As shown, the light/index light detection device 608 detects the first combined light signal 618₁, the second combined light signal 618₂, the third combined light signal 618₃ from the optical combiner 606 and generates scan data (including analog signals in this example). The scan data processing unit 602 is configurable to process the scan data from the light/index light detection device 608 and to generate processed scan data (e.g., digital scan data).

FIG. 6C illustrates the first periodic signal 614₁ and the second periodic signal 614₂ in accordance with some embodiments of this disclosure. As discussed, the first moveable mirror 210₁ oscillates based on the first periodic signal 614₁ and the second moveable mirror 210₂ oscillates based on the second periodic signal 614₂. As discussed above, the second periodic signal 614₂ is equivalent to the first periodic signal 614₁ with phase shift by ¼ period T). For example, when the moveable mirror 210 rotates in a first direction by an angle greater than Θ₀ or in a second direction by an angle less than -Θ₀, the moveable mirror 210 is no longer in a position (e.g., instantaneous angle Θ of the moveable mirror 210) to reflect or re-direct the light from the light source 214 onto the light detector unit 212. Thus, the first optical scanner 602₁ is actively scanning when the first moveable mirror 210₁ is positioned between +Θ₀ (e.g., about 0.7 in FIG. 6C corresponding to 45° in this example) and -Θ₀ (e.g., about -0.7 in FIG. 6C corresponding to -⅛ of the period of the motion in this example). Likewise, the second optical scanner 602₂ will produce an image when the second moveable mirror 210₂ is positioned between +Θ₀ (e.g., about 0.7 in FIG. 6C in this example) and -Θ₀ (e.g., about -0.7 in FIG. 6C in this example). As a result, the first optical scanner 202₁ produces the first light signal 616₁ in a period “A,” a period “C,” and “a period “E.” Likewise, the second optical scanner 202₂ produces the second light signal 616₂ in a period “B,” and a period “E.”

In this example, the scan data/index detection data corresponds to the periods “A,” “C,” and “E” is from the first optical scanner 202₁. Likewise, the scan data/index detection data corresponds to the periods “B,” and “D” is from the second optical scanner 202₂. The instantaneous angle Θ of a moveable mirror 210 at time t is determined by Θ(t)= k × I(t), wherein I(t) can be based on a periodic function (e.g., sine function, cosine function) that repeats for every period T and k is the proportionality constant which may vary.

FIG. 6D illustrates the index light detection data 622 in accordance with some embodiments of this disclosure. The pulse signals (e.g., left pulse signal corresponding to the left index light 218, middle pulse signal corresponding to the middle index light 219, right pulse signal corresponding to right index light 220) described herein are generated by the index light detector 226 and the light/index light detection device 608 in response to detecting the index light from the index light sources 218, 219, 220. Additionally, the moveable mirror 210 rotates or oscillates based on the periodic signal based on periodic function (e.g., sine function, cosine function). For example, the moveable mirror 210 is initially in a horizontal position. At this point (at 0°), the index light detector 226 detects the middle index light 219 and the light/index light detection device 608 outputs a pulse signal M1. As the moveable mirror 210 rotates to the right, the index light detector 226 detects the right index light 220 (at 45° in this example) and the light/index light detection device 608 outputs a pulse signal R1. The moveable mirror 210 keeps rotating to the right direction and changes the rotating direction to the left (at 90° in this example). As the moveable mirror 210 rotates to the left, the index light detector 226 detects the right index light 220 (at 45° in this example) and the light/index light detection device 608 outputs a pulse signal R2. The moveable mirror 210 keeps rotating to the left. When the moveable mirror 210 is the horizontal position (at 0°), the index light detector 226 detects the middle index light 219 and the light/index light detection device 608 outputs a pulse signal M2. As the moveable mirror 210 keeps rotating to the left, the index light detector 226 detects the left index light 198 (at -45° in this example) and the light/index light detection device 608 outputs a pulse signal L1. The moveable mirror 210 keeps rotating to the left direction and changes the rotating direction to the right (at -90° in this example). As the moveable mirror 210 rotates to the right, the index light detector 226 detects the left index light 198 (at -45° in this example) and the light/index light detection device 608 outputs a pulse signal L2. The moveable mirror 210 keeps rotating to the right. When the moveable mirror 210 is in the horizontal position (at 0°), the index light detector 226 detects the middle index light 219 and the light/index light detection device 608 outputs a pulse signal M3.

The error signal generator 601 may have all the information about the periodic function that is used to generate the first signal 614₁. The information may include the length of the period T of the function. However, as will be shown, the error generation is ratio metric, and thus, independent of the driving function’s parameters.

Since the example scanning system 600 is operated in quadrature, the interval time TI 1 between the pulse signal R1 and the pulse signal R2 is ¼ of the period T.

Due to environmental influences, the amplitude (also referred as k) of the first periodic signal 614₁ (based on sine function) may be changed. For example, when the amplitude is greater than normal value (e.g., 1), the interval time TI 1 between the pulse signal R1 and the pulse signal R2 will increase.

The error signal generator 601 may generate feedback 624₁ (e.g., linear error signal, ES) based on:

$$\text{Feedback} \text{=} \frac{1}{4} - \frac{T I 1}{T} \qquad \text{(EQ. 2)}$$

wherein the period of the sine function that is used to generate the first periodic signal 614₁ is T and the interval time between pulse signal R1 and the pulse signal R2 is TI 1. In response to the feedback 624₁, the drive function generator 604 is configured to make adjustments to the first periodic signal 614₁. For example, when the feedback 624₁ indicates a positive value, the drive function generator 604 decreases the amplitude of the first periodic signals 614₁ (e.g., decreasing the amplitude of the first periodic signals 614₁ proportionality). Similarly, when the feedback 624₁ indicates a negative value, the drive function generator 604 increases the amplitude of the first periodic signals 614₁ (e.g., increasing the amplitude of the first periodic signals 614₁ proportionality).

The instantaneous angle Θ of the moveable mirror 210 can be determined by:

$$\text{θ} \left(\text{t}\right) = \text{k} \times \text{I} \left(\text{t}\right) \qquad \text{(EQ. 1)}$$

wherein I(t) can be based on a sine function (e.g., sin (wt)). However, a bias term may be added to the sine function unintentionally due to an imperfect alignment with the moveable mirror 210. For example, when the first moveable mirror 210₁ is misaligned with the first light source unit 214₁, the instantaneous angle Θ of the first moveable mirror 210₁ is operated based on:

$$\text{θ} \left(\text{t}\right) = \text{k} \times \text{I} \left(\text{t}\right) + \text{b} \qquad \text{(EQ. 3)}$$

The bias term b introduced by the imperfect alignment can be determined by

$$\text{b} = \text{TI} 1 - \text{TI} 2 \qquad \text{(EQ. 4)}$$

wherein the interval time between pulse signal R1 and the pulse signal R2 is TI 1, and the interval time between pulse signal L1 and the pulse signal L2 is TI 2. The error signal generator 601 may calculate the bias b using the EQ. 4. In response to the calculating the bias b introduced by the imperfect alignment, the drive function generator 604 may provide the first periodic signal 614₁ based on the function with an offset (-b):

$$\text{θ} \left(\text{t}\right) = \text{k} \times \text{I} \left(\text{t}\right) + \left(\text{-b}\right) \qquad \text{(EQ. 5)}$$

As a result, the first periodic signal 614₁, which is configured to offset the bias due to the imperfect alignment, is provided to the first moveable mirror 210₁.

FIG. 6E illustrates the index light detection data 622 in accordance with some embodiments of this disclosure. The moveable mirror 210 oscillates based on the periodic signal based on periodic function (e.g., sine function, cosine function). For example, the first moveable mirror 210₁ is initially in a horizontal position. At this point (at 0°), the index light detector 226 of the first optical scanner 202₁ detects the middle index light 219 and outputs a pulse signal M1, M2, M3.

As shown in FIG. 6E, due to the unintended delay (unintended phase shift) caused by one or more reasons such as the electromechanical device 211 operational delay, the middle index light 219 of the first optical scanner 202₁ is detected at a wrong time t2 (as indicated by a pulse signal M2d). In other words, the first moveable mirror 210₁ is at the horizontal position at t2 instead of at t1 (e.g., pulse signal M2 in FIG. 6D, at a center of period T of function that is used to generate the first periodic signal 614₁) due to the unintended phase shift. Accordingly, the instantaneous angle Θ of the first moveable mirror 210₁ is operated with the unintended phase shift α:

$$\text{θ} \left(\text{t}\right) = \text{k} \times sin \left(\text{wt} + α\right) \qquad \text{(EQ. 6)}$$

The error signal generator 601 may provide the feedback 624₁ (e.g., linear phase error signal) based on the determined delay time D, the time interval between time t1 and time t2. In response to the feedback 624₁, the drive function generator 604 may determine the unintended phase shift α and may provide the first periodic signal 614₁ based on the function with phase shift offset (- α) as shown:

$$\text{θ} \left(\text{t}\right) = \text{k} \times sin \left(\text{wt} + \left(\text{-} α\right)\right) \qquad \text{(EQ. 7)}$$

Similarly, other optical scanners (e.g., second optical scanner 202₂) may be calibrated. For example, unintended amplitude, bias, and phases shift of second optical scanner 202₂ is determined based on the index light detection data 622.

Methods and systems described herein can be used for correcting a bias error in a scanning mirror of each of the optical scanners, and/or for compensating for a phase response of a scanning mirror of each of the optical scanners while scanning an object or during a training period. Additionally, the methods and systems are disclosed for controlling a plurality of scan amplitudes subject to variations in the proportionality constant k (also referred as amplitude).

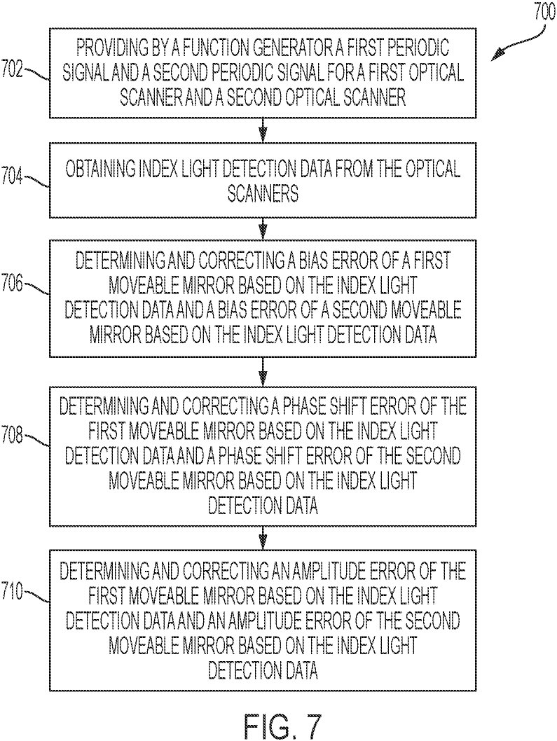

FIG. 7 illustrates a flowchart of an example method 700 for controlling the scanning system 600 including a plurality of optical scanners (e.g., first optical scanner 202₁, second optical scanner 202₂, etc.) in accordance with some embodiments of this disclosure. The method 700 may be performed by processing logic that may include hardware (circuitry, dedicated logic, processor(s), memory, etc.), software (such as is run on a general purpose computer system or a dedicated machine), or a combination of both, which processing logic may be included in any computer system or device. The memory hardware memory is in communication with the data processing hardware. The memory hardware is also configurable to store instructions that when executed on the data processing hardware cause the data processing hardware to perform operations. The operations include receiving index light detection data from an optical scanner. The operations also include determining a bias error of a moveable mirror of the optical scanner based on the index light detection data. The operations include determining a phase shift error of the moveable mirror of the optical scanner based on the index light detection data. The operations also include determining an amplitude error of the moveable mirror of the optical scanner based on the index light detection data. For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification are capable of being stored on an article of manufacture, such as a non-transitory computer-readable medium, to facilitate transporting and transferring such methods to computing devices. As will be appreciated by those skilled in the art, an article of manufacture encompass a computer program accessible from any computer-readable device or storage media. Although illustrated as discrete blocks, various blocks may be divided into additional blocks, combined into fewer blocks, or eliminated, depending on the desired implementation.

The method 700, at operation 702, includes providing by a function generator a first periodic signal and a second periodic signal for a first optical scanner and a second optical scanner. For example operation 702 can use a function generator 604, a first periodic signal 614₁ and a second periodic signal 614₂. The drive function generator 604 is configurable to generates the first periodic signal 614₁ based on a sine function, and the drive function generator 604 generates the second periodic signal 614₂ based on the sine function with ¼ period phase shift. The first moveable mirror 210₁ oscillates based on the first periodic signal 614₁, and the second moveable mirror 210₂ oscillates based on the second periodic signal 614₂.

The method 700, at operation 704, includes obtaining index light detection data from the optical scanners. For example, the operation can use the error signal generator 601, index light detection data 622 from the light/index light detection device 608. As discussed above, the index light detection data 622 includes pulse signals generated by the light/index light detection device 608 in response to detecting of index light from the index light sources 218, 219, 220 as shown in FIG. 6D.

The method 700, at operation 706, includes determining and correcting a bias error of a first moveable mirror based on the index light detection data and a bias error of a second moveable mirror based on the index light detection data. During operation 706, determining and correcting/compensating (e.g., by adding an offset bias value), can be performed by the error signal generator 601 (and the drive function generator 604), using a bias error of the first moveable mirror 210₁ based on the index light detection data 622 and a bias error of the second moveable mirror 210₂ based on the index light detection data 622 as discussed above.

The method 700, at operation 708, includes determining and correcting in a phase shift error of the first moveable mirror based on the index light detection data and a phase shift error of the second moveable mirror based on the index light detection data. The operation 708 of determining and correcting/compensating (e.g., by adding an offset phase shift value), by the error signal generator 601 (and the drive function generator 604), a phase shift error of the first moveable mirror 210₁ can be based on the index light detection data 622 and a phase shift error of the second moveable mirror 210₂ based on the index light detection data 622 as discussed above.

The method 700, at operation 710, includes determining and correcting an amplitude error of the first moveable mirror based on the index light detection data and an amplitude error of the second moveable mirror based on the index light detection data. The operation 710 of determining and correcting/compensating (e.g., by adjusting the amplitude), by the error signal generator 601 (and the drive function generator 604), an amplitude error of the first moveable mirror 210₁ can be based on the index light detection data 622 and an amplitude error of the second moveable mirror 210₂ based on the index light detection data 622 as discussed above.

Operations 702-710 may be carried out while the scanning system 600 is scanning an object.

The disclosed methods, devices and systems allow for controlling a plurality of optical scanners with a single set of electronics. Additionally, the methods, devices and systems provide for correcting a bias error in a scanning mirror of each of the optical scanners, for compensating for a phase response of a scanning mirror of each of the optical scanners, and/or for adjusting the proportionality constant k.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the claims define the scope of the invention and that methods and structures within the scope of these claims and their equivalents be covered thereby.

What is claimed:

1. A scanning system, comprising:
a drive function generator configured to generate a plurality of periodic signals, the plurality of periodic signals including a first periodic signal and a second periodic signal;
a plurality of optical scanners including a first optical scanner and a second optical scanner;
a first mirror of the first optical scanner; and
a second mirror of the second optical scanner;
wherein the first mirror oscillates based on the first periodic signal,
wherein the second mirror oscillates based on the second periodic signal, and
wherein the first periodic signal has a first phase shift and the second periodic signal has a second phase shift different from the first phase shift.

2. The scanning system of claim 1, wherein:
the first phase shift is 0, and
the second phase shift is ¼ period of the second periodic signal.

3. The scanning system of claim 1, wherein:
the drive function generator generates the first periodic signal based on a first sine function with a first phase shift,
the drive function generator generates the second periodic signal based on the first sine function with a second phase shift.

4. The scanning system of claim 3, wherein:
the first phase shift is 0, and
the second phase shift is ¼ period of the first sine function.

5. The scanning system of claim 1, wherein the first optical scanner includes:
a light source device including an array of light sources,
a first index light source,
a second index light source, and
a third index light source.

6. The scanning system of claim 5, wherein:
the first index light source is aligned with a first column of the array of light sources,
the second index light source is aligned with a last column of the array of light sources.

7. The scanning system of claim 5, wherein:
the third index light source is aligned with a center line between a first column of the array of light sources and a last column of the array of light sources.

8. The scanning system of claim 5, wherein:
the third index light source is aligned with a middle column of the array of light sources.

9. The scanning system of claim 5, wherein the first optical scanner further includes:
a light detector unit including a light detector corresponding to one row of the array of light sources and an index light detector disposed to detect index light from the first index light source, the second index light source, and the third index light source.

10. The scanning system of claim 1, further comprising:
a scan data processor configured to receive scan data from the plurality of optical scanners.

11. A method of correcting a periodic signal, the method comprising:
receiving, at one or more processors, index light detection data from an optical scanner;
determining, by the one or more processor, a bias error of a moveable mirror of the optical scanner based on the index light detection data;
determining, by the one or more processor, a phase shift error of the moveable mirror of the optical scanner based on the index light detection data; and
determining, by the one or more processor, an amplitude error of the moveable mirror of the optical scanner based on the index light detection data.

12. The method of claim 11, wherein:
determining the amplitude error of the moveable mirror includes determining a time interval between two consecutive pulses generated by a right index light in the index light detection data.

13. The method of claim 12, the method further comprising:
in response to a determination that there is the amplitude error, adjusting, by the one or more processors, an amplitude of a function that is being used to generate a signal that drives the moveable mirror.

14. The method of claim 11, wherein:
determining the phase shift error of the moveable mirror includes determining a time interval between a first time a middle index pulse is generated by detecting a middle index light and a second time the middle index pulse is supposed to be generated.

15. The method of claim 14, the method further comprising:
in response to a determination that there is the phase shift error, adding, by the one or more processors, an offset phase shift to a function that is being used to generate a signal that drives the moveable mirror.

16. The method of claim 11, wherein:
determining the bias error of the moveable mirror includes determining a first time interval between two consecutive pulses generated by a right index light in the index light detection data, and determining a second time interval between two consecutive pulses generated by a left index light in the index light detection data.

17. The method of claim 16, the method further comprising:
in response to a determination that there is the bias error, adding, by the one or more processors, an offset bias to a function that is being used to generate a signal that drives the moveable mirror.

18. A scanning system, comprising:
data processing hardware; and
memory hardware in communication with the data processing hardware, the memory hardware configurable to store instructions that when executed on the data processing hardware cause the data processing hardware to perform operations comprising:
receive index light detection data from an optical scanner;
determine a bias error of a moveable mirror of the optical scanner based on the index light detection data;
determine a phase shift error of the moveable mirror of the optical scanner based on the index light detection data; and
determine an amplitude error of the moveable mirror of the optical scanner based on the index light detection data.

19. The scanning system of claim 18, wherein:
determine the amplitude error of the moveable mirror includes determine a time interval between two consecutive pulses generated by a right index light in the index light detection data.

20. The scanning system of claim 19, the operation further comprising:
in response to a determination that there is the amplitude error, adjust an amplitude of a function that is being used to generate a signal that drives the moveable mirror.

21. The scanning system of claim 18, wherein:
determine the phase shift error of the moveable mirror includes determine a time interval between a first time a middle index pulse is generated by detecting a middle index light and a second time the middle index pulse is supposed to be generated.

22. The scanning system of claim 21, the operation further comprising:
in response to a determination that there is the phase shift error, add an offset phase shift to a function that is being used to generate a signal that drives the moveable mirror.

23. The scanning system of claim 18, wherein:
determine the bias error of the moveable mirror includes determine a first time interval between two consecutive pulses generated by a right index light in the index light detection data, and determine a second time interval between two consecutive pulses generated by a left index light in the index light detection data.

24. The scanning system of claim 21, the operation further comprising:
in response to a determination that there is the bias error, adding an offset bias to a function that is being used to generate a signal that drives the moveable mirror.
